(19) United States
(12) Patent Application Publication
(10) Pub. No.: US 2011/0248427 A1
(43) Pub. Date: Oct. 13, 2011

(54) PLASTICIZING AND INJECTION UNIT OF AN INJECTION MOULDING MACHINE AND METHOD FOR INJECTION MOULDING

(75) Inventor: Martin GANZ, Perchtoldsdorf (AT)

(73) Assignee: WITTMANN BATTENFELD GMBH, Kottingbrunn (AT)

(21) Appl. No.: 13/071,958

(22) Filed: Mar. 25, 2011

(30) Foreign Application Priority Data
Apr. 9, 2010 (DE) 10 2010 014 451.7

(51) Int. Cl. B29C 45/53; B29C 45/70

(52) U.S. Cl. 264/328.19; 425/557

(57) ABSTRACT

The invention relates to a plasticizing and injection unit (1) of an injection moulding machine To inject especially smallest amounts of plastic melt in an injection moulding tool for injection moulding of small and smallest parts in a process optimized way the unit comprises a screw cylinder (2) in which a plasticizing screw is arranged rotatable and axially movable and an injection element (4) comprising a piston-cylinder system (5, 6), wherein a metered amount of plastic melt, which is deposited in a section (7) of a cylinder (6), is expelled via an injection nozzle (8) into an injection moulding tool by an axial movement of a piston (5) in the cylinder (6), wherein a flow path (9) is arranged between the end of the screw cylinder (2) and the section (7) of the cylinder (6) and wherein the flow path (9) is free from valve elements. Furthermore, the invention relates to a method for injection moulding of a part.

The invention relates to a plasticizing and injection unit of an injection moulding machine, which comprises a screw cylinder in which a plasticizing screw is arranged rotatable and axially movable.

Plasticizing and injection units of this kind are commonly known in the state of the art. Plastic melt is produced by rotation of the screw in the screw cylinder and stored in a volume in front of the screw (space in front of the screw). When a sufficient amount of melt is plasticized the melt is injected into the injection moulding tool by an axial movement of the screw via the injection nozzle.

Units according to the above mentioned kind are known from DD 6262 A1, from US 2004/0026809 A1 and from EP 1 095 753 A1.

In the case that only small and smallest amounts of melt are required to fill the cavity of the injection moulding tool, if thus very small parts are to be injection moulded (so called micro injection moulding), this method is not suitable. It is known to forward melt by the rotation of the screw directly into an injection element. When the injection element being designed as a piston-cylinder-element is filled sufficiently with melt the same is injected into the injection moulding tool by an axial movement of a piston. Thus, a separation of the plasticizing, the metering and the injection of melt takes place here.

Also this method is not suitable any more if the amount of melt which is required for filling of the injection moulding tool is only minimal.

Thus, it is an object of the invention to propose a plasticizing and injection unit of an injection moulding machine as well as a method for its operation by which it is possible to plasticize smallest amounts of melt and to inject them into an injection moulding tool. Thereby, it is also set value on a good possibility for the cleaning of the system and a gentle treatment and a gentle injection of the material so that the quality of the moulded parts is high.

The solution according to the invention is characterized in that the plasticizing and injection unit of the injection moulding machine comprises a screw cylinder in which a plasticizing screw is arranged rotatable and axially movable and an injection element comprising a piston-cylinder system, wherein a metered amount of plastic melt, which is deposited in a section of a cylinder, is expelled via an injection nozzle into an injection moulding tool by an axial movement of a piston in the cylinder, wherein a flow path is arranged between the end of the screw cylinder and the section of the cylinder and wherein the flow path is free from valve elements.

The flow path consists preferably of a bore without further elements which could influence the flow of the melt.

The injection nozzle and the cylinder are preferably made as one part. It can have a bore for the piston, which has a constant diameter till the axial end of the injection nozzle which is facing the injection moulding tool. This has the significant advantage that practically all melt material which is deposited in the section of the cylinder can be expelled from the injection nozzle by displacement of the piston till the end of the injection nozzle. Thus, no residual melt remains in the injection nozzle.

The piston can be held in a first position in which a fluidic connection exists between the flow path and the section of the cylinder, wherein the piston can be held in a second position in which the fluidic connection between the flow path and the section of the cylinder is disabled or interrupted.

The longitudinal axis of the screw cylinder and the axis of cylinder of the injection element are preferably arranged under an angle between 30° and 80°, preferably between 45° and 65°.

A pressure sensor can be arranged in the region of the flow path. By this sensor the back pressure can be detected in a very precise manner.

The piston can be connected with an axial actuator at its end remote from the cylinder, wherein the actuator preferably comprises a linear drive, especially at least one circular belt which is driven by a servomotor, wherein a circumference point of the belt is connected with the piston directly or indirectly. It is also possible that the piston is connected with an axial actuator at its end remote from the cylinder which axial actuator comprises a piston rod, wherein the piston rod is connected with one of its ends with the piston and with its other end with a crank arm which can be rotated by a servomotor.

By this a very dynamic and precise movement of the piston can be generated by which the injection process can be controlled dynamically and precisely.

The screw cylinder and the injection nozzle are preferably surrounded by heating elements.

To make it possible to do without specific elements for the prevention of a back flow of melt it is preferred that the plasticizing screw is designed as a multizone screw, especially as a three, four or five zone screw.

The method for the injection moulding of a moulded part with the mentioned apparatus is characterized by the following steps:
a) moving of the piston in a position, in which the fluidic connection between the flow path and the section of the cylinder is interrupted in which section plastic melt to be injected can be deposited;
b) plasticizing of plastic melt by rotating of the plasticizing screw and metering of plastic melt in a volume between the end of the plasticizing screw and the flow path as well as in the flow path;
c) moving of the piston in a position in which the fluidic connection between the flow path and the section of the cylinder is freed in which section plastic melt to be injected can be deposited;
d) axial displacement of the plasticizing screw for expelling of plastic melt from the volume between the end of the plasticizing screw and the flow path as well as from the flow path in the section of the cylinder and depositing of a defined amount of plastic melt in the section;
e) axial displacement of the piston for injection of the plastic melt being deposited in the section via the injection nozzle.

The metering of the plastic melt according step b) can take place in such a manner, that a defined back pressure in the volume between the end of the plasticizing screw and the flow path is maintained.

The injection of the plastic melt according to step e) can take place in such a manner, that a defined injection pressure in the injection nozzle is maintained.

The invention is thus basing on the concept that in a first step the plasticizing of the plastic material, the metering of the same and the transfer of the melt takes place by the screw, while in a second step the injection is carried out by means of the piston.

The following advantages can be obtained especially for the precision and micro injection moulding with the proposed system and the method respectively:

An injection of thermal homogeneous material takes place. A cold plug of material can be avoided because no residual material remains between the cold toot and the hot aggregate. The melt cushion is only minimal; this is beneficially when only very small amounts of melt are required per shot. The flow path of the melt is very short. During injection only small drops in pressure take place.

All standard granulates can be processes without problems. The plasticizing takes place with a relatively low applied load onto the material. The metering of the melt can take place with relatively low pressures; the material is thus treated gently. No unnecessary redirection of the melt is necessary; this is also beneficial with respect to the melt material. A further benefit is the first-in-first-out principle for the operation of the melt. The pre-metering can be carried out with low power which is also beneficially with respect to the energy saving. The injection pressure is build up very close to the injection moulding tool. The measurement of the injection pressure can take place in a simple manner by measuring the force which acts on the injection piston during injection. The transfer of the plasticized melt material from the space in front of the screw into the injection cylinder can be carried out by a small stroke of the plasticizing screw of e. g. 2 cm. The back stroke of the screw takes place during the metering of the material for the next shot.

By the use of the injection piston as closure for the flow path non-return valves can be relinquished; this would be problematic in the case of micro injection moulding.

Shot weights are possible which can be below 50 mg. The injection can be carried out in a highly dynamic manner without overswing. A safe process as well as a high degree of repeat accuracy are given.

Leakage of material can be avoided easier as in the case of pre-known solutions—due to lack of respective valves and other controlling elements in the flow path. The measurement of the back pressure can take place directly and thus more precisely by the proposed sensor. Thereby, a precise control of the back pressure can take place what increases the accuracy of metering respectively. This is very beneficially for electrical machines because no injection pressure acts in the region of the sensor, i.e. the injection pressure does not influence the back pressure. Thus, the sensor must only resist the maximal back pressure.

A three, four or five zone plasticizing screw prevents the flow back of material so that insofar further measures (non-return valves) can be avoided for preventing the flow back of melt. But it is also possible that a non-return valve is arranged in the region of the screw.

The system is designed in an easy way and can thus be realized in a cost efficient manner. Also the assembly is possible without problems and thus cost effective. The cleaning of the system is possible in a simple manner—due to the lack of valves and other controlling elements.

A further benefit is the possibility to rebuild existing systems according to the invention.

In the drawing an embodiment of the invention is shown.

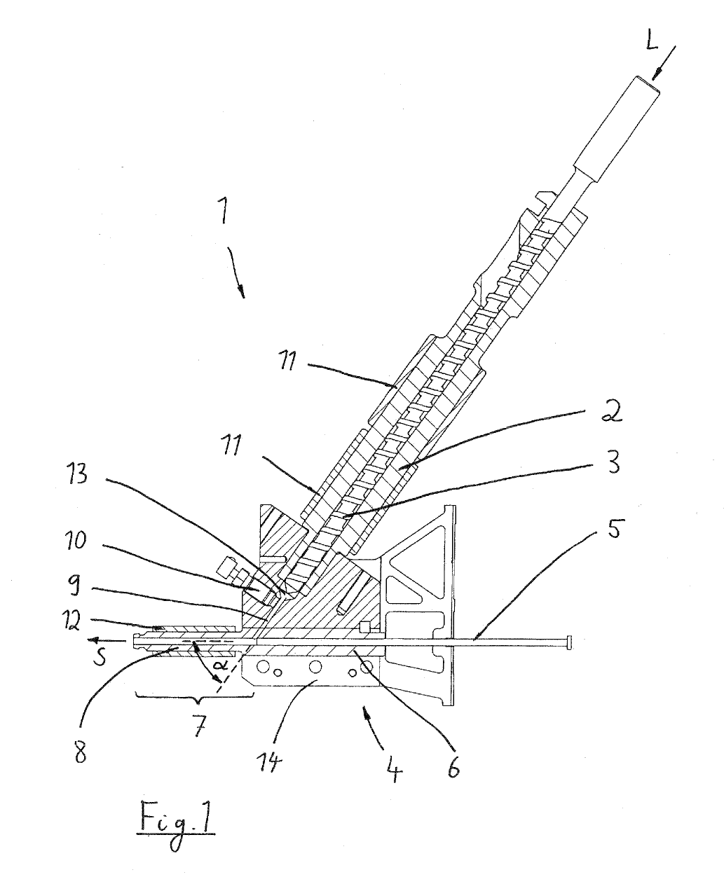

FIG. 1 shows a cross section of the front view of a plasticizing and injection unit of an injection moulding machine for micro injection moulding,

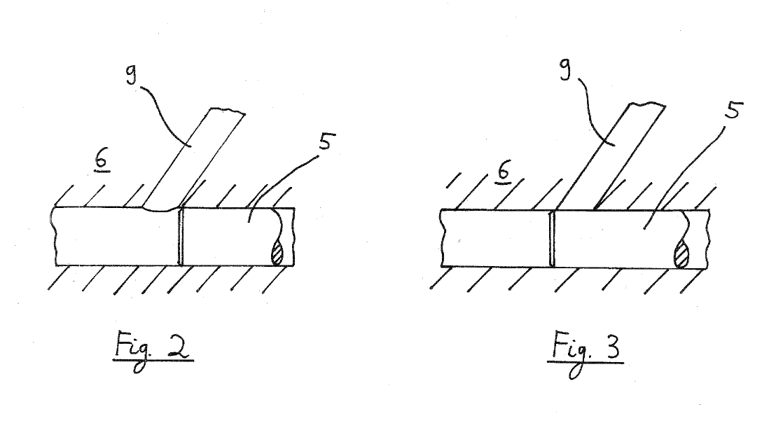

FIG. 2 shows in an enlarged depiction a detail from FIG. 1, namely the transition from a flow path into a piston-cylinder-system of the injection element, wherein the flow path is in fluidic connection with the cylinder chamber,

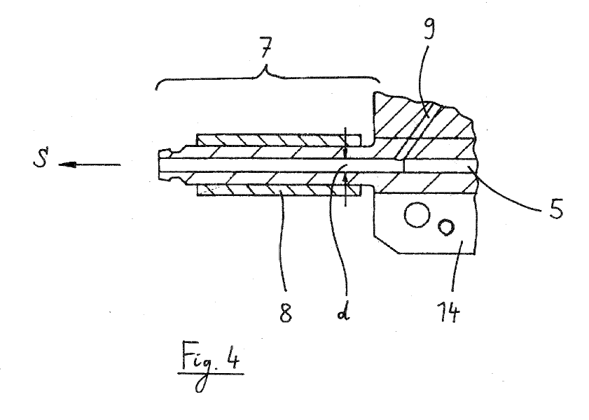

FIG. 3 shows the same depiction as in FIG. 2, wherein the fluidic connection between the flow path and the cylinder chamber is interrupted, and

FIG. 4 shows an enlarged section from FIG. 1 with the depiction of the injection nozzle.

In FIG. 1 a plasticizing and injection unit 1 is shown which is designed for the injection moulding of small and smallest moulded parts, i.e. for the micro injection moulding. The plasticizing and injection unit 1 comprises in its upper region a screw cylinder 2 in which a plasticizing screw 3 is arranged rotatable as well as axially movable. Because the means for the rotational drive and for the axial movement are commonly known in the state of the art they are not shown. The plasticizing screw 3 moves during its axial movement in the direction of the longitudinal axis L of the screw cylinder 2.

Furthermore the plasticizing and injection unit 1 comprises an injection element 4 which has a piston-cylinder-system. Here, a piston 5 is arranged in a cylinder 6, wherein the piston is displaceable in the direction of the axis S of the cylinder.

An angle α is enclosed between the longitudinal axis L of the screw cylinder 2 and the axis S of the cylinder 6, which angle is presently about 55°.

The fluidic connection between a volume 13 in front of the plasticizing screw 3 (space in front of the screw) and the inner space of the cylinder 6 is established by a flow path 9 which is designed as an undisturbed bore. Thus, plasticized plastic melt can flow from the volume 13 via the flow path 9 into a section 7 of the cylinder bore, which is designed as an injection nozzle 8. To avoid freezing of plasticized plastic material the screw cylinder 2 as well as the injection nozzle 8 are surrounded by heating elements 11, 12. Also the distributor block 14 of the unit can be tempered with heating elements which are not depicted.

A pressure sensor 10 abuts to the flow path 9 which can detect the back pressure in the flow path 9 precisely.

It is essential that the flow path 9 is designed as a bore which is free from control elements (valves) by which the flow of plastic melt can be influenced. Instead, the transition of the flow path 9 to the bore of the cylinder 6 is designed in a special way, as it is apparent from FIGS. 2 and 3.

Accordingly, the piston 5 can be positioned on the one hand in a position (see FIG. 2) in which a fluidic connection between the flow path 9 and the bore of the cylinder 6 exists. In this position plasticized plastic can reach the bore of the cylinder 6, i.e. the injection nozzle 8, via the flow path 9 by carrying out an axial displacement movement of the plasticizing screw 3.

However, if the piston 5 is moved a bit further as depicted in FIG. 3 this fluidic connection is interrupted. This is also the case when the piston 5—after deposition of a desired amount of plastic melt in the bore of the cylinder 6—is moved axially (in FIG. 3 to the left hand side) to inject this amount of melt into the injection moulding tool.

During the closure of the connection between the flow path 9 and the bore in the cylinder 6 plastic material for the next shot can be metered and stored in the volume 13; during this process the plasticizing screw 3 is again axially retracted into its initial position.

During the injection of melt by means of the piston 5 the metering of the material for the next shot can take place simultaneously by the plasticizing screw 3.

In FIG. 4 an enlarged depiction of the unit is shown with the region which comprises the injection nozzle 8. Here, it can be seen in detail that the bore in the injection nozzle 8 with the diameter d extends to the end of the injection nozzle 8. Accordingly, the piston 5 can be moved (in FIG. 4 to the left side) until it is flush with the axial end of the injection nozzle 8. By doing so practically all plastic melt is expelled out from the unit 1 so that—what is just important in the case of micro injection moulding—no residual melt remains in the injection nozzle 8. So the injection nozzle is kept automatically clean and fully operative.

### LIST OF REFERENCE NUMERALS

1 plasticizing and injection unit
2 screw cylinder
3 plasticizing screw
4 injection element
5, 6 piston-cylinder system
5 piston
6 cylinder
7 section
8 injection nozzle
9 flow path
10 pressure sensor
11 heating element
12 heating element
13 volume
14 distributor block
L longitudinal axis
S axis of cylinder
α angle
d diameter

1. Plasticizing and injection unit (1) of an injection moulding machine comprising:
a screw cylinder (2) in which a plasticizing screw is arranged rotatable and axially movable and
an injection element (4) comprising a piston-cylinder system (5, 6), wherein a metered amount of plastic melt, which is deposited in a section (7) of a cylinder (6), is expelled via an injection nozzle (8) into an injection moulding tool by an axial movement of a piston (5) in the cylinder (6),
wherein a flow path (9) is arranged between the end of the screw cylinder (2) and the section (7) of the cylinder (6) and
wherein the flow path (9) is free from valve elements.

2. Plasticizing and injection unit according to claim 1, characterized in that the injection nozzle (8) and the cylinder (6) are made as one part.

3. Plasticizing and injection unit according to claim 1 characterized in that the injection nozzle (8) has a bore for the piston (5), which has a constant diameter (d) till the axial end of the injection nozzle (8) which is facing the injection moulding tool.

4. Plasticizing and injection unit according to claim 1, characterized in that the piston (5) can be held in a first position in which a fluidic connection exists between the flow path (9) and the section (7) of the cylinder (6) and that the piston (5) can be held in a second position in which the fluidic connection between the flow path (9) and the section (7) of the cylinder (6) is disabled.

5. Plasticizing and injection unit according to claim 1, characterized in that the longitudinal axis (L) of the screw cylinder (2) and the axis of cylinder (S) of the injection element (4) are arranged under an angle (α) between 30° and 80°, preferably between 45° and 65°.

6. Plasticizing and injection unit according to claim 1, characterized in that a pressure sensor (10) is arranged in the region of the flow path (9).

7. Plasticizing and injection unit according to claim 1, characterized in that the piston (5) is connected with an axial actuator at its end remote from the cylinder (6), wherein the actuator comprises a linear drive, especially at least one circular belt which is driven by a servomotor, wherein a circumference point of the belt is connected with the piston (5) directly or indirectly.

8. Plasticizing and injection unit according to claim 1, characterized in that the screw cylinder (2) and the injection nozzle (8) are surrounded by heating elements (11, 12).

9. Plasticizing and injection unit according to claim 1, characterized in that the plasticizing screw (3) is designed as a multizone screw, especially as a three, four or five zone screw.

10. Method for the injection moulding of a moulded part with an apparatus according to claim 1
characterized in that it comprises the steps of:
a) moving of the piston (5) in a position, in which the fluidic connection between the flow path (9) and the section (7) of the cylinder (6) is interrupted in which section (7) plastic melt to be injected can be deposited;
b) plasticizing of plastic melt by rotating of the plasticizing screw (3) and metering of plastic melt in a volume (13) between the end of the plasticizing screw (3) and the flow path (9) as well as in the flow path (9);
c) moving of the piston (5) in a position in which the fluidic connection between the flow path (9) and the section (7) of the cylinder (6) is freed in which section (7) plastic melt to be injected can be deposited;
d) axial displacement of the plasticizing screw (3) for expelling of plastic melt from the volume (13) between the end of the plasticizing screw (3) and the flow path (9) as well as from the flow path (9) in the section (7) of the cylinder (6) and depositing of a defined amount of plastic melt in the section (7);
e) axial displacement of the piston (5) for injection of the plastic melt being deposited in the section (7) via the injection nozzle (8).

11. Method according to claim 10, characterized in that the metering of the plastic melt according step b) of claim 10 takes place in such a manner, that a defined back pressure in the volume (13) between the end of the plasticizing screw (3) and the flow path (9) is maintained.

12. Method according to claim 10, characterized in that the injection of the plastic melt according to step e) of claim 10 takes place in such a manner, that a defined injection pressure in the injection nozzle (8) is maintained.
